(19) United States
(12) Patent Application Publication
(10) Pub. No.: US 2002/0126482 A1
(43) Pub. Date: Sep. 12, 2002

(54) Detachable christmas ornamental ball

(76) Inventor: Ming-Hsiung Chen, Taipei City (TW)

Correspondence Address: Richard P. Berg, Ladas & Parry, Suite #2100, 5670 Wilshire Boulevard, Los Angeles, CA, 90036-5679, US

(21) Appl. No.: 09/804,497

(22) Filed: Mar. 12, 2001

(51) Int. Cl. F21V 21/00

(52) U.S. Cl. 362/249; 362/252

(57) ABSTRACT

A detachable Christmas ornamental ball includes a light penetrable spherical shell having an opening sufficient for the insertion of a C-type lamp bulb, and a cap-like top cover detachably fastened to the opening of the spherical shell to hold a C-type lamp socket and a C-type lamp bulb in the spherical shell, the top cover having a peripheral wall defining a bottom open chamber, two springy hook plates formed integral with the peripheral wall at two opposite sides and respectively hooked on the periphery of the opening of the spherical shell to secure the top cover to the spherical shell, a plurality of splits cut through the peripheral wall at two opposite lateral sides of each of the springy hook plates, and two springy oblique retaining plates suspended in the bottom open chamber and adapted to hold a C-type lamp socket in the spherical shell.

### BACKGROUND OF THE INVENTION

The present invention relates to lamps and, more particularly, to a detachable Christmas ornamental ball, which comprises a spherical shell, a top cover detachably hooked on an opening of the spherical shell to hold a C-type lamp socket in the spherical shell and a C-type lamp bulb in the C-type lamp socket inside the spherical shell.

C-type lamp light strings A and decorative balls B are commonly used to decorate Christmas trees (see FIG. 1). These decorative balls B fixed with cylindrical cover on the topside commonly have a diameter at about 6˜10 cm, and an outside wall electroplated with a colored coating of a particular design. Because these decorative balls B are not designed to hold a lamp bulb on the inside, the design of these decorative balls B are indicative only under the illumination of external light source. Further, there are Christmas ornamental devices designed for attaching to each mini lamp of a light string. When a mini lamp of a light string is inserted into a Christmas ornamental device, the light of the mini lamp is not with sufficient illumination to evenly distribute through the peripheral wall of the Christmas ornamental device, and the design of the Christmas ornamental device is not easy to see.

### SUMMARY OF THE INVENTION

It is one object of the present invention to provide a detachable Christmas ornamental ball, which top cover can easily detachably be adapted to hold a C-type socket. It is another object of the present invention to provide a detachable Christmas ornamental ball, which has a diameter about 6˜10 cm adapted to receive a 7 W C-type lamp so that sufficient illumination can be provided on the inside, enabling the design of the ornamental ball to be well seen. To achieve these and other objects of the present invention, a detachable Christmas ornamental ball is provided comprising a light penetrable spherical shell having an opening sufficient for the insertion of a C-type lamp bulb, and a cap-like top cover detachably fastened to the opening of the spherical shell to hold a C-type lamp socket and a C-type lamp bulb in the spherical shell, the top cover having a peripheral wall defining a bottom open chamber, two springy hook plates formed integral with the peripheral wall at two opposite sides and respectively hooked on the periphery of the opening of the spherical shell to secure the top cover to the spherical shell, a plurality of splits cut through the peripheral wall at two opposite lateral sides of each of the springy hook plates, and two springy oblique retaining plates suspended in the bottom open chamber and adapted to hold a C-type lamp socket in the spherical shell. By means of squeezing the hook plates of the top cover inwards, the top cover and the C-type lamp socket with the installed C-type lamp bulb can easily be removed from the spherical shell for a replacement of the C-type lamp bulb.

### BRIEF DESCRIPTION OF THE DRAWINGS

FIG. 1 illustrates a C-type lamp light string and decorative balls installed in a Christmas tree according to the prior art.

FIG. 2 is an exploded view of a detachable Christmas ornamental ball according to a first embodiment of the present invention.

FIG. 3 is an assembly view of FIG. 2.

FIG. 4 is a sectional plain view of the assembly of FIG. 3.

FIG. 5A is a sectional plain view showing the hook plates of the top cover aimed at the opening of the spherical shell according to the first embodiment of the present invention.

FIG. 5B is a sectional plain view showing the sloping bottom edge of each of the hook plates of the top cover respectively stopped against the peripheral edge of the opening of the spherical shell according to the first embodiment of the present invention.

FIG. 5C is a sectional plain view showing the hooked bottom retaining flange of each of the hook plates of the top cover hooked on the peripheral edge of the opening of the spherical shell according to the first embodiment of the present invention.

FIG. 6A is a sectional plain view showing the C-type lamp socket aimed at the bottom open chamber of the top cover according to the first embodiment of the present invention.

FIG. 6B is a sectional plain view showing the topside of the C-type lamp socket stopped against the bottom ends of the springy oblique retaining plates of the top cover according to the first embodiment of the present invention.

FIG. 6C is a sectional plain view showing the C-type lamp socket inserted into the holding space between the springy oblique retaining plates of the top cover, the spring oblique retaining plates of the top cover clamped on the C-type lamp socket according to the first embodiment of the present invention.

FIG. 7 is an exploded view of a detachable Christmas ornamental ball according to a second embodiment of the present invention.

FIG. 8 is an assembly view of FIG. 7.

FIG. 9 is a sectional plain view of the assembly of FIG. 8.

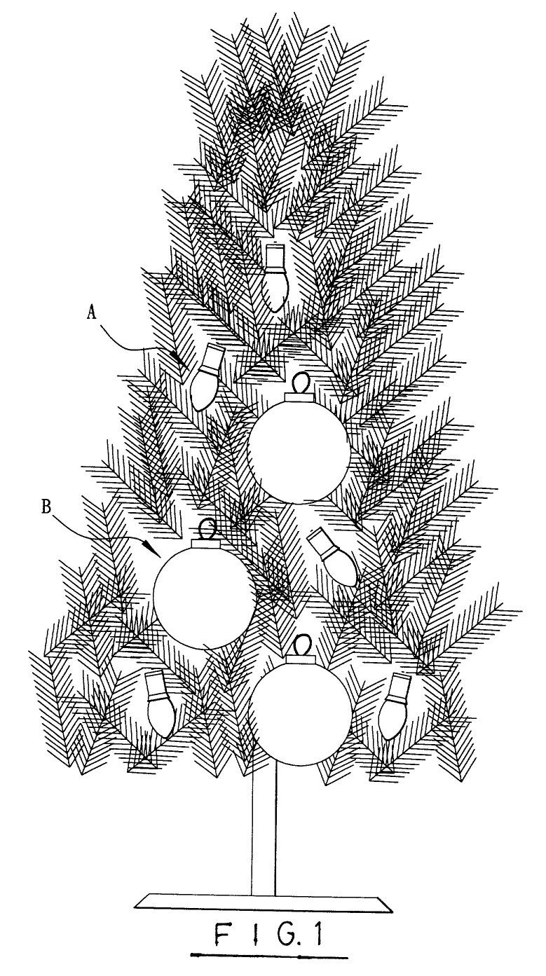

### DETAILED DESCRIPTION OF THE PREFERRED EMBODIMENT

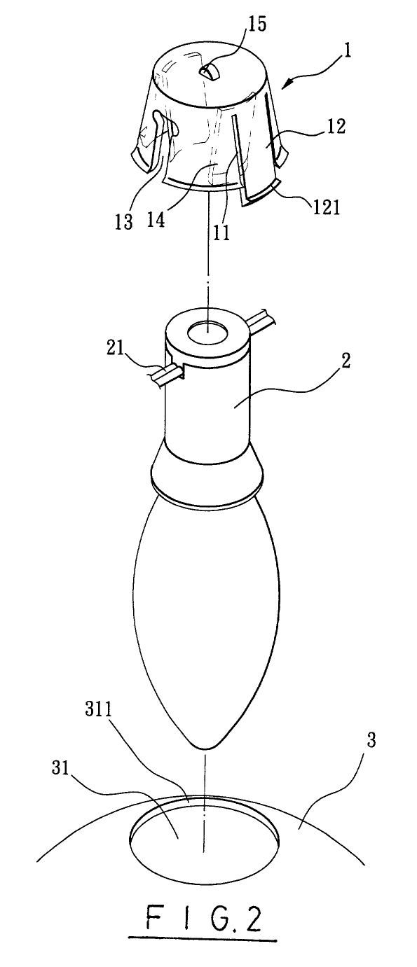

Referring to FIGS. 2, 3, 4, and 5A, a detachable Christmas ornamental ball is designed for decorating a Christmas tree or the like, comprising a top cover 1, a C-type lamp socket 2 holding a C-type lamp bulb, and a spherical shell 3. The top cover 1 is made of springy material (For example, thin metal sheet, plastics, or the like). According to the present preferred embodiment, the top cover 1 is shaped like a cylindrical cap having a peripheral wall that defines a bottom open chamber. Two springy hook plates 12 are formed integral with the peripheral wall of the top cover 1 at two opposite sides. Two springy oblique retaining plates 14 are downwardly inwardly extended from the top sidewall of the top cover 1 and suspended in the bottom open chamber of the top cover 1 between the hook plates 12, and two peripheral openings 13 disposed at two opposite sides and respectively equally spaced between the hook plates 12. The hook plates 12 are formed of the peripheral wall of the top cover 1, each having two lateral sides separated from the peripheral wall of the top cover 1 by splits 11, and a hooked bottom retaining flange 121. Because of the design of the splits 11, the hook plates 12 have a long arm of force and high spring power. The hooked bottom retaining flange 121 has a downwardly inwardly extended sloping bottom edge 122. The downwardly inwardly suspended oblique retaining plates 14 define a holding space adapted to hold the C-type lamp socket 2. The horizontal distance between the bottom ends of the retaining plates 14 is slightly shorter than the outer diameter of the C-type lamp socket 2. The peripheral openings 13 of the top cover 1 are adapted to receive an electric wire 21 being fastened to the C-type lamp socket 2. Further, an eyelet 15 is provided at the top sidewall of the top cover 1 on the outside for hanging. The spherical shell 3 has an opening 31. Through the opening 31, the C-type lamp socket 2 and the bulb on the C-type lamp socket 2 are inserted into the inside of the spherical shell 3. The inside wall as well as the outside wall of the spherical shell 3 may be coated with a layer of light-penetrable color coating, or painted with a particular design.

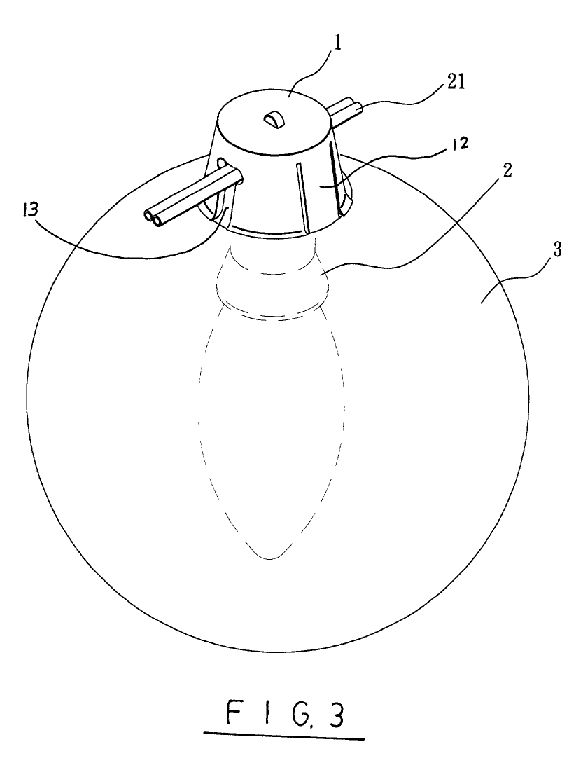

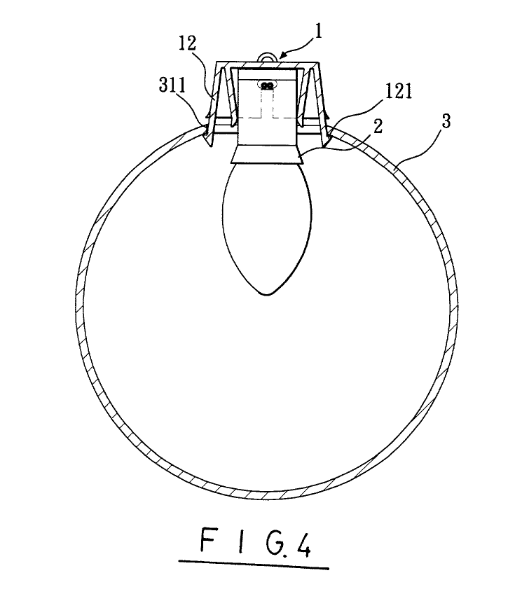

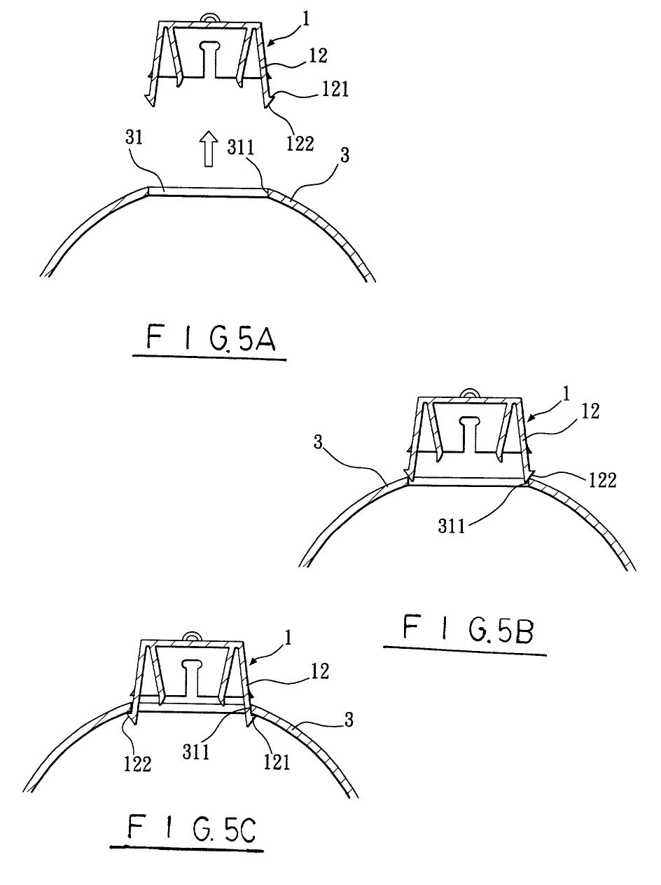

The assembly of the top cover 1 and the spherical shell 3 are described hereinafter with reference to FIGS. 3 and 4 and FIGS. from 5A through 5C. The hook plates 12 of the top cover 1 are aimed at the opening 31 of the spherical shell 3 (see FIG. 5A), and then the hook plates 12 are squeezed inwards and inserted into the opening 31 of the spherical shell 3. At the initial stage when inserting the hook plates 12 into the opening 31 of the spherical shell 3, the sloping bottom edge 122 of the hooked bottom retaining flange 121 of each of the hook plates 12 is respectively stopped against the peripheral edge 311 of the opening 31 of the spherical shell 3 (see FIG. 5B). Because the sloping bottom edge 122 of the hooked bottom retaining flange 121 of each of the hook plates 12 of the top cover 1 slopes downwardly inwards, the hook plates 12 can easily be inserted into the opening 31 of the spherical shell 3. After the sloping bottom edge 122 of the hooked bottom retaining flange 121 of each of the hook plates 12 of the top cover 1 passes over the peripheral edge 311 of the opening 31 of the spherical shell 3, the material spring power of the hook plates 12 immediately forces the hooked bottom retaining flange 121 of each of the hook plates 12 of the top cover 1 into engagement with the peripheral edge 311 of the opening 31 of the spherical shell 3 (see FIG. 5C). Thus, the top cover 1 is fastened to the spherical shell 3 to hold the C-type lamp socket 2 and the C-type lamp bulb in the spherical shell 3.

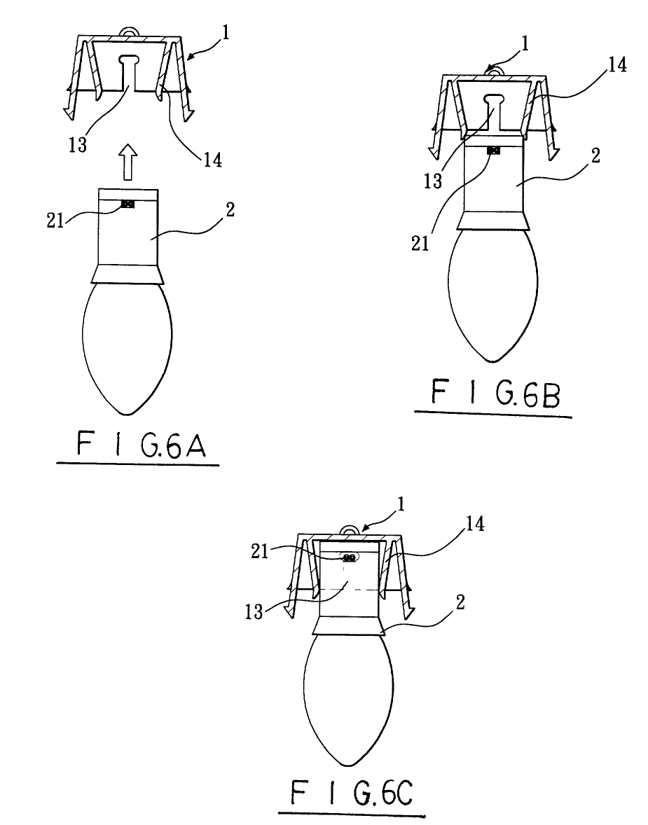

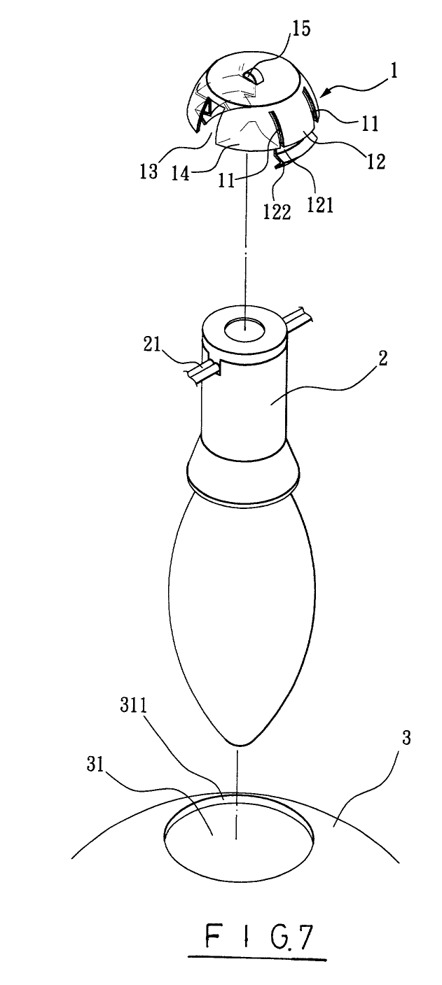

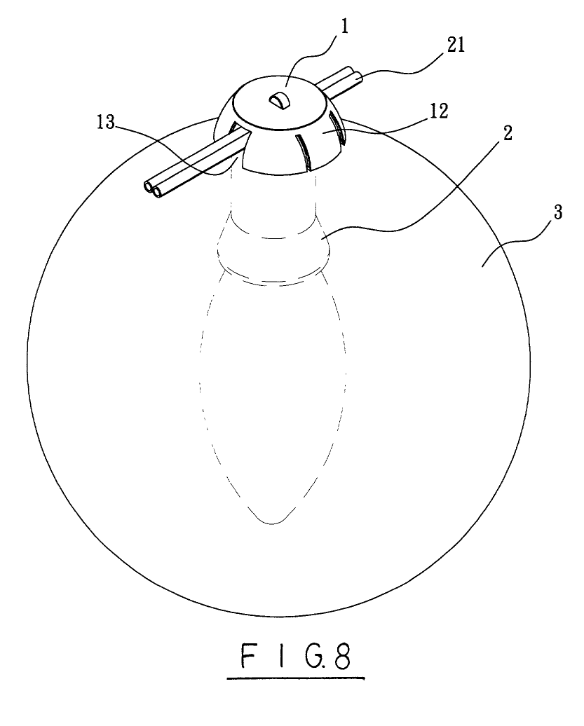

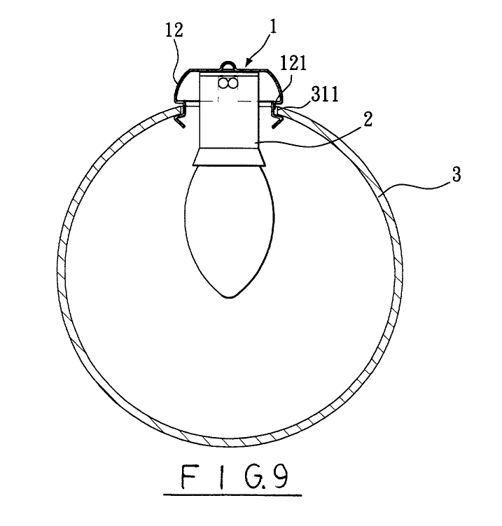

The assembly of the top cover 1 and the C-type lamp socket 2 is described hereinafter with reference to FIGS. from 6A through 6C. The C-type lamp socket 2 is aimed at the bottom open chamber of the top cover 1 (see FIG. 6A), and then the topside of the C-type lamp socket 2 is stopped against the bottom ends of the springy oblique retaining plates 14 of the top cover 1 (see FIG. 6B) and forced into the holding space between the retaining plates 14 of the top cover 1 (see FIG. 6C). When inserting the C-type lamp socket 2 into the holding space between the retaining plates 14 of the top cover 1, the retaining plates 14 are deformed and respectively forced outwards. After the C-type lamp socket 2 has been set into position, the retaining plates 14 immediately return to their former shape and clamped on the periphery of the C-type lamp socket 2 to hold down the C-type lamp socket 2 in the top cover 1 (see FIG. 6C). When assembled, the electric wire 21 fastened to the C-type lamp socket 2 passes through the peripheral openings 13 of the top cover 1.

After the assembly of the top cover 1 and the C-type lamp socket 2, the top cover 1 is fastened to the peripheral edge 311 of the opening 31 of the spherical shell 3 to hold the C-type lamp socket 2 and the C-type lamp bulb inside the spherical shell 3. According to the present preferred embodiment, the spherical shell 3 can have a diameter at about 6˜10 cm, and the C-type lamp bulb to be used with the C-type lamp socket 2 is of about 7 W. When connecting electricity to the C-type lamp socket 2 through the electric wire 21, the C-type lamp bulb is driven to emit sufficient light through the spherical shell 3 and to illuminate the various designs painted on the detachable Christmas ornamental ball.

In case the C-type lamp bulb is damaged, the top cover 1 and the C-type lamp socket 2 can easily be removed from the spherical shell 3. When squeezing the hook plates 12 inwards with two fingers, the hooked bottom retaining flange 121 of each of the hook plates 12 is respectively disengaged from the peripheral edge 311 of the opening 31 of the spherical shell 3, enabling the top cover 1 and the C-type lamps socket 2 to be separated from the spherical shell 3. After replacement of the damaged C-type lamp bulb, the top cover 2 is fastened to the peripheral edge 311 of the opening 31 of the spherical shell 3 to hold the C-type lamp socket 2 and the new C-type lamp bulb inside the spherical shell 3.

FIGS. from 7 through 9 show an alternate form of the present invention. According to this alternate form, the detachable Christmas ornamental ball comprises a top cover 1, a C-type lamp socket 2 fastened to an electric wire 21 and holding a C-type lamp bulb, and a spherical shell 3. The C-type lamp socket 2 and the spherical shell 3 are similar to the respective members of the aforesaid first embodiment of the present invention. Te top cover 1 comprises is shaped like a round cap having a peripheral wall that defines a bottom open chamber. Similar to the top cover of the aforesaid first embodiment of the present invention, the top cover 1 of this alternate form comprises two springy hook plates 12 formed integral with the peripheral wall of the top cover 1 at two opposite sides, the hook plates 12 each having two lateral sides separated from the peripheral wall of the top cover 1 by splits 11, two springy oblique retaining plates 14 inwardly extended from the sidewall thereof and suspended in the bottom open chamber between the hook plates 12, and two peripheral openings 13 disposed at two opposite sides and respectively equally spaced between the hook plates 12. The hook plates 12 are formed of the peripheral wall of the top cover 1, each having a corrugated bottom retaining flange 121. Because of the design of the splits 11, the hook plates 12 have a long arm of force and high spring power. The corrugated bottom retaining flange 121 has a downwardly inwardly extended sloping bottom edge 122. The inwardly suspended oblique retaining plates 14 define a holding space adapted to hold the C-type lamp socket 2. The horizontal distance between the bottom ends of the retaining plates 14 is slightly shorter than the outer diameter of the C-type lamp socket 2. After the C-type lamp socket 2 has been fastened to the retaining plates 14 of the top cover 1, the hook plates 12 of the top cover 1 are squeezed inwards and inserted into the opening 31 of the spherical shell 3. At the initial stage when inserting the hook plates 12 into the opening 31 of the spherical shell 3, the sloping bottom edge 122 of the corrugated bottom retaining flange 121 of each of the hook plates 12 is respectively stopped against the peripheral edge 311 of the opening 31 of the spherical shell 3. Because the sloping edge 122 of the corrugated bottom retaining flange 121 of each of the hook plates 12 of the top cover 1 slopes downwardly inwards, the hook plates 12 can easily be inserted into the opening 31 of the spherical shell 3. After the sloping bottom edge 122 of the corrugated bottom retaining flange 121 of each of the hook plates 12 of the top cover 1 passes over the peripheral edge 311 of the opening 31 of the spherical shell 3, the material spring power of the hook plates 12 immediately forces the corrugated bottom retaining flange 121 of each of the hook plates 12 of the top cover 1 into engagement with the peripheral edge 311 of the opening 31 of the spherical shell 3. Thus, the top cover 1 is fastened to the spherical shell 3 to hold the C-type lamp socket 2 and the C-type lamp bulb in the spherical shell 3.

A prototype of detachable Christmas ornamental ball has been constructed with the features of FIGS. 2˜9. The detachable Christmas ornamental ball functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A detachable Christmas ornamental ball comprising:
a spherical shell, said spherical shell having an opening sufficient for the insertion of a C-type lamp bulb into said spherical shell; and
a top cover fastened to the opening of said spherical shell to hold a C-type lamp socket and a C-type lamp bulb in said spherical shell, said top cover comprising a peripheral wall defining a bottom open chamber, two springy hook plates formed integral with said peripheral wall at two opposite sides and respectively hooked on the periphery of said opening of said spherical shell to secure said top cover to said spherical shell, a plurality of splits cut through said peripheral wall at two opposite lateral sides of each of said springy hook plates, two peripheral openings and two springy oblique retaining plates suspended in said bottom open chamber between said hook plates and adapted to hold a C-type lamp socket in said spherical shell.

2. The detachable Christmas ornamental ball of claim 1 wherein said two peripheral openings of said top cover for the passing of an electric wire are fastened to said C-type lamp socket.

3. The detachable Christmas ornamental ball of claim 1 wherein said hook plates of said top cover each comprise a hooked bottom retaining flange adapted to hook on the periphery of the opening of said spherical shell.

4. The detachable Christmas ornamental ball of claim 1 wherein said springy oblique retaining plates are inwardly extended from sidewall of said top cover toward the center of said bottom open chamber for adapting to hold a C-type lamp socket.
